(19) United States
(12) Patent Application Publication
(10) Pub. No.: US 2023/0115728 A1
(43) Pub. Date: Apr. 13, 2023

(54) LOCALIZED SUBSERVICE SYSTEM AND METHOD TO PROVIDE IMPROVED CORE NETWORK SERVICES

(71) Applicant: CenturyLink Intellectual Property LLC, Broomfield, CO (US)

(72) Inventors: John R.B. Woodworth, Amissville, VA (US); Dean Ballew, Sterling, VA (US)

(73) Assignee: CenturyLink Intellectual Property LLC, Broomfield, CO (US)

(21) Appl. No.: 17/822,453

(22) Filed: Aug. 26, 2022

Related U.S. Application Data
(60) Provisional application No. 63/254,603, filed on Oct. 12, 2021.

(51) Int. Cl. H04L 67/5682

(52) U.S. Cl. CPC H04L 67/5682; H04L 67/02

(57) ABSTRACT

A system includes: a webserver system configured to host a dynamic webpage; a requestor device configured to communicate with the webserver system over a first network to receive the dynamic webpage; and a resource device communicably connected to the requestor device over a second network, and configured to cache a core-static webpage corresponding to the dynamic webpage. In response to the webserver system being unavailable to provide the dynamic webpage, the requestor device is configured to communicate with the resource device over the second network to request the core-static webpage.

### CROSS-REFERENCE TO RELATED APPLICATIONS

This application claims the benefit of U.S. Provisional Application No. 63/254,603, filed on or about Oct. 12, 2021, and entitled “Localized Subservice System and Method to Provide Improved Core Network Services,” which is incorporated herein by reference in its entirety.

### BACKGROUND

Some rural and underserved service areas may use unstable network components (e.g., transoceanic cable links, and/or the like). When these network components fail, Internet services may become intermittent or unavailable. As a result, access to websites and core services may be intermittent or unavailable.

The above information disclosed in this Background section is for enhancement of understanding of the background of the present disclosure, and therefore, it may contain information that does not constitute prior art.

### SUMMARY

One or more examples of the present disclosure are directed to a localized subservice system to provide core-static webpages when dynamic webpages are unavailable.

One or more examples of the present disclosure are directed to a method of providing core-static webpages when dynamic webpages are unavailable.

According to one or more examples of the present disclosure, a system includes: a webserver system configured to host a dynamic webpage; a requestor device configured to communicate with the webserver system over a first network to receive the dynamic webpage; and a resource device communicably connected to the requestor device over a second network, and configured to cache a core-static webpage corresponding to the dynamic webpage. In response to the webserver system being unavailable to provide the dynamic webpage, the requestor device is configured to communicate with the resource device over the second network to request the core-static webpage.

In some examples, the resource device may be communicably connected to the webserver system over the first network, and may be configured to receive the core-static webpage from the webserver system.

In some examples, the resource device may include a first web client/browser configured to: request code for the dynamic webpage from the webserver system; interpret the code to display a main page of the dynamic webpage; identify the core-static webpage from a link in the code; and fetch the core-static webpage from the link to cache the core-static webpage.

In some examples, the system may further include a link proxy communicably connected to each of the resource device and the requestor device over the second network, the link proxy configured to provide connection information of the resource device to the requestor device and to provide connection information of the requestor device to the resource device.

In some examples, the connection information of the resource device may include a public Internet protocol (IP) address and port of a first router connected to the resource device, and the connection information of the requestor device may include a public IP and port of a second router connected to the requestor device.

In some examples, the resource device and the requestor device may be configured to directly communicate with each other using the first router and the second router according to the connection information received from the link proxy.

In some examples, the resource device and the requestor device may be configured to directly communicate with each other using user datagram protocol (UDP) hole-punching.

In some examples, the resource device and the requestor device may be configured to directly communicate with each other using transmission control protocol (TCP) hole-punching.

In some examples, the resource device may be configured to transmit an announcement query to the link proxy, the announcement query including information related to the core-static webpage cached thereon and the public IP and port of the first router.

In some examples, the requestor device may be configured to transmit a request query to the link proxy, the request query comprising information related to the requested core-static webpage and the public IP and port of the second router.

### BRIEF DESCRIPTION OF THE DRAWINGS

The above and other aspects and features of the present disclosure will be more clearly understood from the following detailed description of the illustrative, non-limiting example examples with reference to the accompanying drawings.

FIG. 1 illustrates a localized subservice system according to one or more examples of the present disclosure.

FIG. 2 illustrates a localized subservice system according to one or more examples of the present disclosure.

FIG. 3 illustrates a user device of the localized subservice system according to one or more examples of the present disclosure.

FIG. 4 illustrates a method of storing a core-static webpage according to one or more examples of the present disclosure.

FIG. 5 illustrates a link proxy of the localized subservice system according to one or more examples of the present disclosure.

FIG. 6 illustrates a method of announcing a resource of a core-static webpage according to one or more examples of the present disclosure.

FIGS. 7-8 illustrate a method of requesting a resource of a core-static webpage according to one or more examples of the present disclosure.

FIG. 9 illustrates a method of providing a core-static webpage according to one or more examples of the present disclosure.

### DETAILED DESCRIPTION

Hereinafter, examples will be described in more detail with reference to the accompanying drawings, in which like reference numbers refer to like elements throughout. The present disclosure, however, may be embodied in various different forms, and should not be construed as being limited to only the illustrated examples herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

Generally, when Internet services are unavailable, access to external websites and other core services may be unavailable. For example, when a web client/browser of a user device attempts to communicate with a webserver or web server proxy device over the Internet to request a dynamic website of a webpage provider hosted by the webserver system, the webserver system may be unreachable due to the unavailability of the Internet services. In this case, the user may be presented with a generic error page (e.g., 404 error page) and/or the like, for example, when the web client/browser of the user device times out after being unable to communicate with the webserver system. One or more webserver or webserver proxy device is/are collectively referred to herein as “webserver system.”

According to one or more examples of the present disclosure, however, when the webserver system is unreachable to provide the dynamic website, a core-statics version (e.g., a core-static webpage) of the dynamic website may be provided instead, such that a user experience may be improved. For example, in some examples, the user device may still be connected to one or more other devices via a local network, even when Internet services are unavailable. In this case, the other devices may host (e.g., may store or may temporarily store) the core-static webpage of the dynamic website, such that the user device may communicate with the other devices over the local network to request the core-static webpage of the dynamic website.

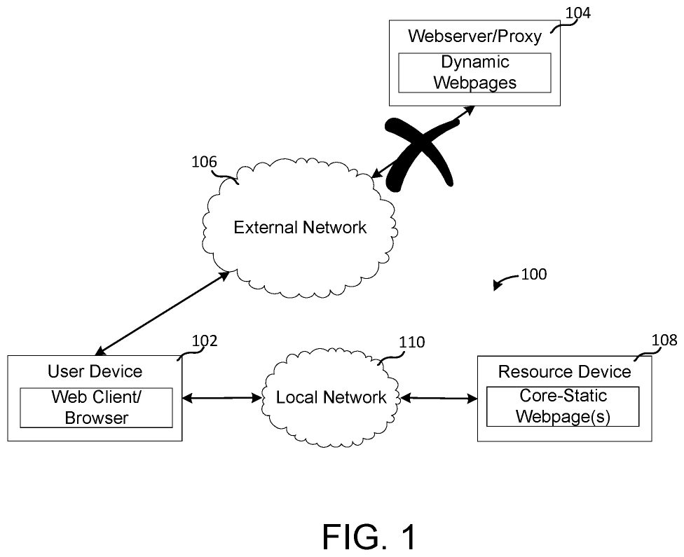

FIG. 1 illustrates a localized subservice system according to one or more examples of the present disclosure.

Referring to FIG. 1, the localized subservice system 100 may include a user device 102. The user device 102 may be communicably connected to a webserver system 104 hosting dynamic webpages that are accessible by a web client/browser of the user device 102 over an external communications network 106, such as the Internet. In the illustrated example(s), the webserver system 104 is depicted as one or more of a webserver and/or webserver proxy device. The dynamic webpages may be part of a dynamic website of a webpage provider hosted by the webserver system 104, and accessible by the user device 102 via a Uniform Resource Locator (URL) or other suitable link. The user device 102 may include any suitable electronic computing device, for example, such as a personal computer (PC), a laptop computer, a tablet, a smart phone, a smart watch, smart glasses, and/or the like.

The localized subservice system 100 may further include a resource device 108 communicably connected to the user device 102 over a local communications network 110. The resource device 108 may host core-static webpages that are accessible by the web client/browser of the user device 102 over the local communications network 110. The core-static webpages may correspond to the dynamic website of the webpage provider. In some examples, the core-static webpages may be simplified webpages or a lightweight version of the webpages compared to the dynamic webpages of the dynamic website hosted by the webserver system 104. For example, the core-static webpages may include a branded error page with some useful information (e.g., contact information, such as a customer care number, address, email, and/or the like), webpages with limited functionality when compared to the dynamic webpages, webpages having content in a simplified format (e.g., a plain-text format) when compared to the dynamic webpages, web pages that include only static information and no active links to other information, and/or the like.

The resource device 108 may store (e.g., may cache or temporarily store) the core-static webpages, and may provide the core-static webpages to the user device 102 over the local communications network 110 as needed or desired. In some examples, the resource device 108 may also be connected to the external network 106 to receive the core-static webpages from the webserver system 104 or a different device or server over the external network 106, but the present disclosure is not limited thereto. For example, the resource device 108 may receive the core-static webpages from any suitable source using a direct device-to-device connection or over any suitable network connection. For convenience, the resource device 108 may be described in more detail below as another user device that is communicably connected to the local communications network 110, but the present disclosure is not limited thereto. In other examples, the resource device 108 may include any suitable computing device that is communicably connected to the user device 102 over the local network 110 and capable of storing or providing access to the core-static webpages, for example, such as another user device 102, an Internet of Things (IoT) device, a router, a network card, a load balancer, a server (e.g., a Domain Name System (DNS) server), and/or the like.

As a non-limiting example, the user device 102 may attempt to retrieve the dynamic webpages from the webserver system 104 over the external communications network 106, but for whatever reason, the webserver system 104 may be unavailable. For example, the user device 102 may have an unstable or unavailable connection to the external network 106, or the webserver system 104 may be down or may have an unstable or unavailable connection to the external network 106. In any event, the user device 102 may still be communicably connected to the resource device 108 over the local network 110, and in response to the dynamic webpages being unavailable from the webserver system 104 over the external network 106, may request the core-static webpages from the resource device 108 over the local network 110. Accordingly, rather than displaying a generic error page (e.g., a 404 error page) when the dynamic webpages are unavailable, cores-static webpages including a branded error page with some useful information, a simplified or lightweight version of the dynamic webpages, and/or the like may be provided, such that a user experience may be improved.

The external communications network 106 may be structured to enable the exchange of data, values, instructions, messages, and/or the like among the devices connected thereto (e.g., the user device 102, the resource device 108, and/or the webserver system 104). The local communications network 110 may be structured to enable the exchange of data, values, instructions, messages, and/or the like among the devices connected thereto (e.g., the user device 102 and the resource device 108). Each of the external communications network 106 and the local communications network 110 may include any suitable wired or wireless network (e.g., a Local Area Network (LAN), a Wide Area Network (WAN), cellular communications network, and/or the like) that are different from each other. For example, the external network 106 may include the Internet (e.g., a WAN), and the local network 110 may include a LAN, but the present disclosure is not limited thereto.

Each of the networks 106 and 110 may include any suitable one or more from among Frequency Division Multiple Access (FDMA), Time Division Multiple Access (TDMA), Code Division Multiple Access (CDMA) (e.g., Evolution-Data Optimized (EVDO)), Universal Mobile Telecommunications Systems (UMTS) (e.g., Time Division Synchronous CDMA (TD-SCDMA or TDS)), Wideband Code Division Multiple Access (WCDMA), Long Term Evolution (LTE), evolved Multimedia Broadcast Multicast Services (eMBMS), High-Speed Downlink Packet Access (HSDPA), Universal Terrestrial Radio Access (UTRA), Global System for Mobile Communications (GSM), Code Division Multiple Access 1x Radio Transmission Technology (1×), General Packet Radio Service (GPRS), Personal Communications Service (PCS), 802.11X, Bluetooth, Wi-Fi, any suitable wired network, combinations thereof, and/or the like, that are different from each other such that even when the external network 106 is unavailable, the user device 102 and the resource device 108 may still communicate with each other over the local network 110.

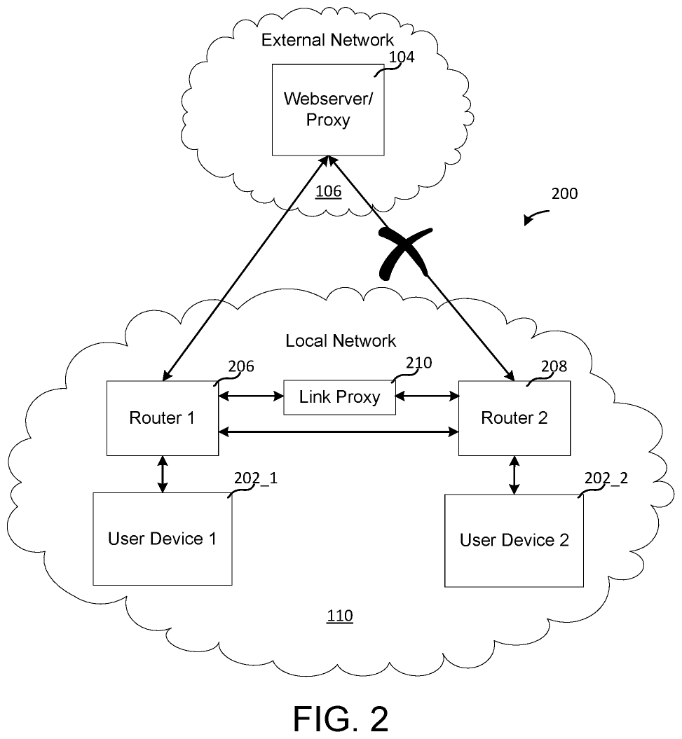

FIG. 2 illustrates a localized subservice system according to one or more examples of the present disclosure. The localized subservice system 200 shown in FIG. 2 is provided as an example implementation of the localized subservice system 100 shown in FIG. 1, but the present disclosure is not limited thereto. In FIG. 2, the same reference symbols are used to denote the same or substantially the same elements and components as those described above with reference to FIG. 1, and thus, redundant description thereof may not be repeated or may be simplified.

Referring to FIG. 2, the localized subservice system 200 may include a first user device (user device 1) 202_1 and a second user device (user device 2) 202_2, each communicably connected to the webserver system 104 hosting the dynamic webpages of a dynamic website of a webpage provider over the external network 106. For example, the first user device 202_1 may be communicably connected to the webserver system 104 via a first router (router 1) 206 over the external network 106, and the second user device 202_2 may be communicably connected to the webserver system 104 via a second router (router 2) 208 over the external network 106. Each of the first and second routers 206 and 208 may connect a corresponding user device 202_1 or 202_2 to one or more external devices (e.g., the webserver system 104, the other user device 202_1 or 202_2, a link proxy 210, an edge DNS server, and/or the like). For example, each of the first and second routers 206 and 208 may translate a private Internet protocol (IP) space used by a corresponding user device 202_1 or 202_2 to a public IP space for communicating with the external devices and vice versa. In some examples, each of the first and second routers 206 and 208 may be a network address translation (NAT) router or the like. However, the present disclosure is not limited thereto, and each of the first and second routers 206 and 208 may include any suitable kind of router known to those skilled in the art for facilitating communications between the corresponding user device 202_1 or 202_2 and the external devices.

The first user device 202_1 may be communicably connected to the second user device 202_2 over the local network 110 (e.g., via their routers 206 and 208). In the example shown in FIG. 2, the first user device 202_1 may correspond to (e.g., may be) the resource device 108 of FIG. 1, and the second user device 202_2 may correspond to (e.g., may be) the user device (e.g., a requesting device) 102 of FIG. 1. Accordingly, the first user device 202_1 may store (e.g., may cache) the core-static webpages of the dynamic website, and may provide the core-static webpages to the second user device 202_2 as needed or desired, for example, when the second user device 202_1 is unable to establish communications with the webserver system 104 to access the dynamic webpages of the dynamic website. However, the present disclosure is not limited thereto, and it should be appreciated that each of the first and second user devices 202_1 and 202_2 may be a resource device storing the same or different core-static webpages for the same or different dynamic websites, such that the first and second user devices 202_1 and 202_2 may be resource devices for various same or different core-static webpages in a distributed fashion for various devices connected through the local network 110.

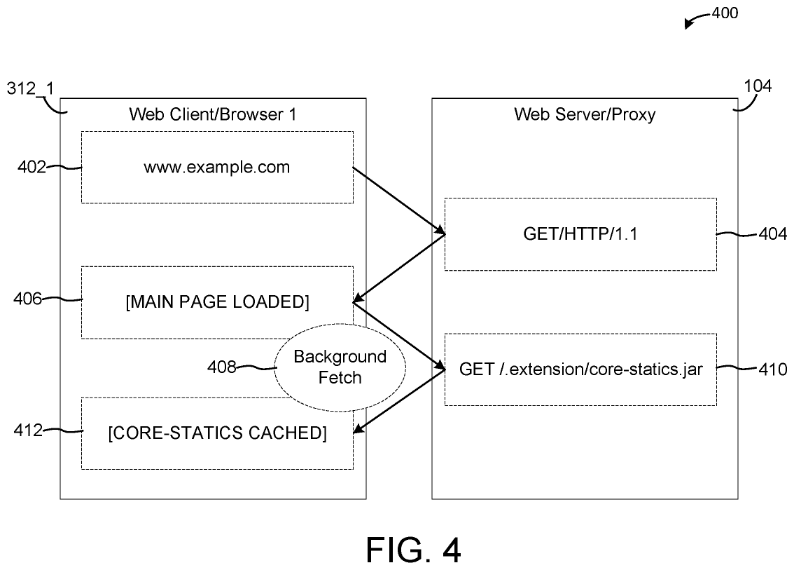

As will be discussed in more detail below with reference to FIG. 4, the first user device 202_1 may have had previous communications with the webserver system 104 to access the dynamic webpages, and in conjunction with doing so, may also have received the core-static webpages corresponding to the dynamic website to be stored thereon from the webserver proxy 104. For example, the first user device 202_1 may receive the core-static webpages from the webserver system 104 every time the first user device 202_1 accesses the dynamic website, or may receive the core-static webpages from the webserver system 104 when the connection to the external network 106 or the webserver system 104 is deemed unreliable (e.g., an anticipated outage period, low signal strength, geographical location of the first user device 202_1 is known to have unreliable connections, the connection is down some percentage of time in a particular rolling time period, and/or the like). Subsequently, when the second user device 202_2 requests the dynamic webpages from the webserver system 104, the webserver system 104 may be unresponsive. For example, the second user device 202_2 may lose connection to the external network 106, or the webserver system 104 may be down or may lose connection to the external network 106. In response to the webserver system 104 being unresponsive, the second user device 202_2 may communicate with the first user device 202_1 (e.g., via their routers 206 and 208) to request the core-static webpages for the dynamic website stored on the second user device 202_2.

For example, in some examples, the first and second user devices 202_1 and 202_2 may establish a communications link with each other via their routers 206 and 208. In order to traverse packets through their routers 206 and 208, a suitable hole-punching method may be used, for example, such as a user datagram protocol (UDP) hole-punching method or a transmission control protocol (TCP) hole-punching method. For example, if the core-static webpages are relatively complex and require multiple packet transmissions such that the receipt of each of the packets by the requestor device is an important factor, then the TCP hole-punching method may be used to employ its stringent handshaking and pairing down requirements. On the other hand, if the core-static webpages are fairly simple and lightweight such that the guaranteed receipt of the packet by the requestor device is less important than the transmission of the packet by the resource device, then the UDP hole-punching method may be used. For convenience, the localized subservice system 200 may be described in more detail hereinafter in the context of a UDP hole punching method, but the present disclosure is not limited thereto.

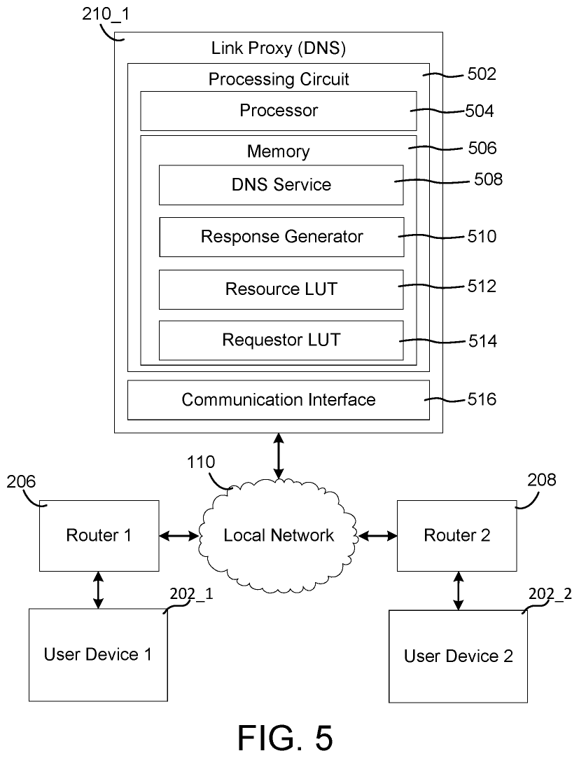

Accordingly, in some examples, each of the first and second user devices 102 and 104 may be communicably connected to a link proxy 210 over the local network 114. The link proxy 210 may orchestrate a communications link between the first user device 202_1 and the second user device 202_2. For example, as will be described in more detail below with reference to FIGS. 5-9, in order for the packets to traverse through the routers 206 and 208, the link proxy 210 my orchestrate IP and port combination states between the routers 206 and 208 to enable direct communications between the first and second user devices 102 and 104 (e.g., via their routers 206 and 208). While the link proxy 210 is described in more detail hereinafter in the context of a DNS server (e.g., a DNS/Proxy 210_1 in FIG. 5), the present disclosure is not limited thereto, and the link proxy 210 may be implemented as (or may be included in) any suitable device or server that may orchestrate communications between a resource device and a requestor device (e.g., the first and second user devices 202_1 and 202_2, respectively).

As described in more detail below, in some examples, after the first user device 202_1 receives the core-static webpages for the dynamic website hosted by the webserver system 104, the first user device 202_1 may announce to the link proxy 210 (e.g., via the first router 206) that it has the core-static webpages for the dynamic website available. The link proxy 210 may record the IP address and port combination of the first router 206 that was used for the announcement. Subsequently, when the second user device 202_2 is unable to retrieve the dynamic webpages from the webserver system 104, the second user device may transmit a request for the corresponding core-static webpages to the link proxy 210 (e.g., via the second router 208). The link proxy 210 may record the IP address and port combination of the second router 208 that was used for the request. The link proxy 210 may transmit a response to the first user device 202_1 providing the IP address and port combination used by the second user device 202_2 (e.g., the second router 208), and may transmit a response to the second user device 202_2 providing the IP address and port combination used by the first user device 202_1 (e.g., the first router 206). The first and second user devices 202_1 and 202_2 may then directly communicate with each other (e.g., via their routers 206 and 208) using the IP and port combinations provided by the link proxy 210.

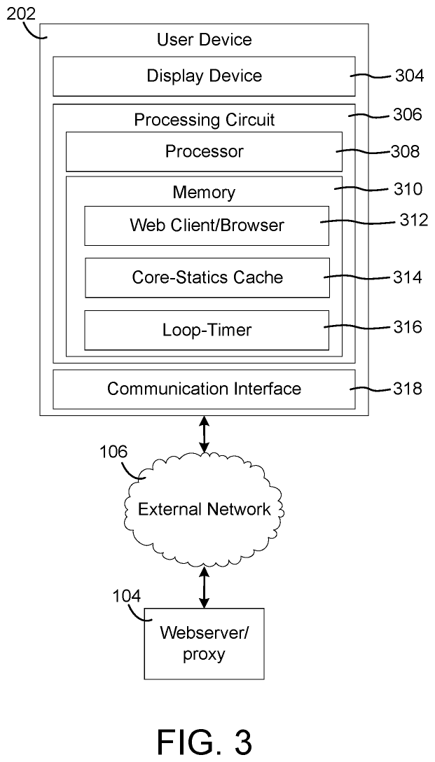

FIG. 3 illustrates a user device of the localized subservice system according to one or more examples of the present disclosure. At least one of the first user device 202_1 or the second user device 202_2 shown in FIG. 2 may have the same or substantially the same structure as that of the user device 202 shown in FIG. 3. For example, in an embodiment, each of the first user device 202_1 and the second user device 202_2 may participate as a resource device in the localized subservice system hosting various core-static webpages for various dynamic websites, and in this case, each of the first user device 202_1 and the second user device 202_2 may have the same or substantially the same structure as that of the user device 202 shown in FIG. 3. In FIG. 3, the same reference symbols are used to denote the same or substantially the same elements and components as those described above with reference to one or more examples, and thus, redundant description thereof may not be repeated or may be simplified.

Referring to FIG. 3, the user device 202 may be communicably connected to the webserver system 104 over the external network 106 to display (e.g., via a web client/browser 312) a dynamic webpage hosted by the webserver system 106 on a display device 304. The user device 202 may include the display device 304, or may be connected to the display device 304 to display webpages (e.g., dynamic webpages or core-static webpages) thereon. In some examples, the user device 202 may be connected to the external network 106 via a router (e.g., the first router 206 or the second router 208), for example, as shown in FIG. 2. As shown in FIGS. 1 and 2, the user device 202 may also be communicably connected to the local network 110 (e.g., via a router) to communicate with one or more devices connected through the local network 110. The user device 202 may include any suitable electronic computing device, for example, such as a personal computer (PC), a laptop computer, a tablet, a smart phone, a smart watch, smart glasses, and/or the like.

The user device 202 may include a processing circuit 306 having a processor 308 and memory 310. In various examples, the processor 308 may include a general-purpose processor, an Application Specific Integrated Circuit (ASIC), one or more Field Programmable Gate Arrays (FPGAs), a Digital Signal Processor (DSP), any other suitable electronic processing components, or combinations thereof. The memory 310 may include tangible, non-transitory, volatile memory or non-volatile memory, for example, such as Random Access Memory (RAM), Read-Only Memory (ROM), Non-volatile RAM (NVRAM), Flash Memory, hard disk storage, any other suitable electronic storage medium, or combinations thereof. The memory 310 stores instructions (e.g., data, computer code, and/or programming logic) that, when executed by the processor 308, controls the operations of the user device 202. Accordingly, the memory 310 includes database components, object code components, script components, and/or any other type of information structure for supporting the various activities and information structures described herein.

In some examples, the memory 310 may include a web client/browser 312. The web client/browser 312 communicates with the webserver system 104 over the external communications network 106 to request one or more dynamic webpages for display on the display device 304. For example, the web client/browser 312 may transmit (e.g., via a URL, an IP address, and/or the like) a request (e.g., HTTP GET) to the webserver system 104 for a requested dynamic webpage, and may receive a response (e.g., HTTP POST) from the webserver system 104 including code (e.g., HTML, XML, and/or the like) corresponding to the requested dynamic webpage. The web client/browser 312 interprets the code, retrieves any images or other content according to the code (e.g., according to URLs or other suitable links to the images and other content contained in the code), and displays the requested dynamic webpage including the retrieved images and other content on the display device 110 according to the code.

In some examples, the memory 310 may further include a core-statics cache 314, for example, if the user device 202 is participating as a resource device. For example, as discussed in more detail below with reference to FIG. 4, in some examples, if the user device 202 participates as a resource device in hosting core-static webpages for the dynamic website, the web client/browser 312 may further receive one or more core-static webpages from the webserver system 104 to be stored in the core-statics cache 314. For example, in some examples, the code of the requested dynamic webpage may further include a link to fetch the core-static webpages. In this case, the web client/browser 312 may fetch the core-static webpages according to the code (e.g., according to URLs or other suitable links to the core-static webpages contained in the code), and may store the core-static webpages in the core-statics cache 314 to be made available to other devices connected through the local network 110. However, the present disclosure is not limited thereto, and the user device 202 (or other suitable core-statics hosting device) may receive the core-static webpages (e.g., from the webserver system 104 or other device or server associated with the webpage provider of the dynamic website) using any suitable methods known to those skilled in the art.

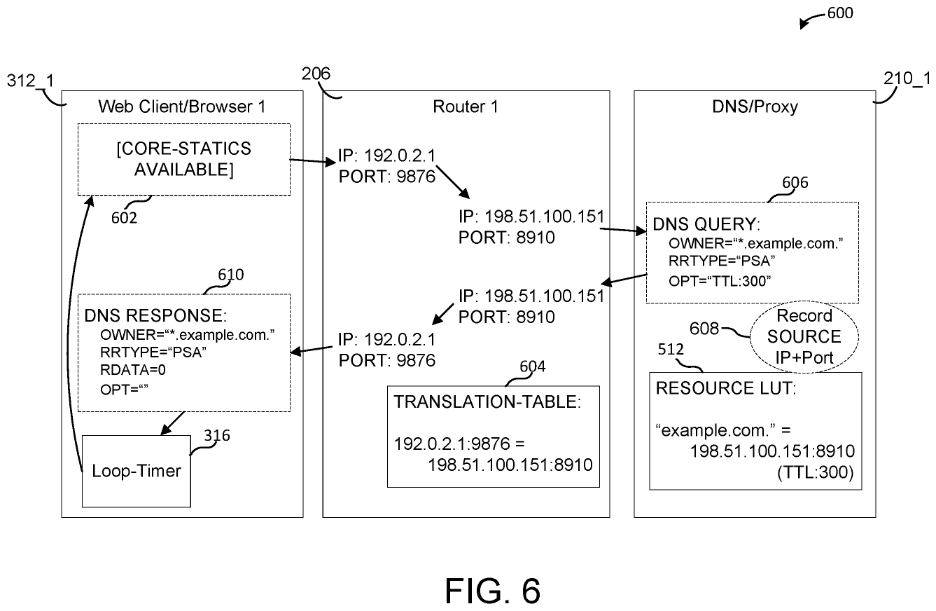

In some examples, the web client/browser 312 may make the core-static webpages available for a configurable duration of time, for example, to enable the user to control the amount of resources of the user device 202 that may be used to cache the core-static webpages. For example, in some examples, the memory 310 may further include a loop-timer 316. The loop-timer 316 may provide a tunable control mechanism for the amount of time that the core-static webpages are available from the user device 202 to be served to other devices (e.g., a requesting device 102). For example, in some examples, as discussed in more detail below with reference to FIG. 6, the loop-timer 316 may provide a tunable mechanism to extend the time to live (TTL) of the core-static webpages that are made available from the core-statics cache 314. However, the present disclosure is not limited thereto, and in other examples, the loop-timer 316 may be omitted depending on an implementation of the resource device (e.g., the user device 202). For example, if the resource device 108 (e.g., see FIG. 1) is a dedicated resource device for storing and providing core-static webpages, then the loop-timer 316 may be omitted.

The user device 202 further includes a communication interface 318. The user device 202 may be communicably connected to the external network 106 and/or the local network 110 via the communication interface 318. For example, the communication interface 318 may be or include wired or wireless communications interfaces (e.g., jacks, antennas, transmitters, receivers, transceivers, wire terminals, and/or the like) for conducting data communications with the webserver system 104, the link proxy 210, and/or other devices connected through the external network 106 and/or the local network 110. In various examples, communications via the communication interface 318 can be direct (e.g., local wired or wireless communications) or via the networks 106 and/or 110 (e.g., a WAN, the Internet, a cellular network, and/or the like). For example, the communication interface 318 may include a Wi-Fi transceiver for communicating via a wireless communications network. In another example, the communication interface 318 may include an Ethernet card and port for sending and receiving data via an Ethernet-based communications link or network. In another example, the communication interface 318 may include cellular or mobile phone communications transceivers. In various examples, the communication interface 318 may support various suitable protocols (e.g., TCP/IP, UDP, Hypertext Transfer Protocol HTTP, Internet Message Access Protocol IMAP, Simple Mail Transfer Protocol SMTP, and/or the like) and/or data communication interfaces (e.g., Application Program Interface API, Web Services, and/or the like) for facilitating data communications with the webserver system 104, the link proxy 210, and/or the like over the external network 106 and/or the local network 110.

FIG. 4 illustrates a method of storing a core-static webpage according to one or more examples of the present disclosure. However, the present disclosure is not limited to the sequence or number of operations of the method 400 shown in FIG. 4, and can be altered into any desired sequence or number of operations as recognized by a person having ordinary skill in the art. For example, in some examples, the order may vary, or the method 400 may include fewer or additional operations. Further, the operations shown in the method 400 may be performed sequentially, or at least some of the operations thereof may be performed concurrently (e.g., simultaneously or substantially simultaneously).

Referring to FIG. 4, a first web client/browser (web client/browser 1) 312_1 of the first user device 202_1 (e.g., the resource device) may communicate with the web server/proxy 104 (e.g., via the external network 106) to request a dynamic webpage of a dynamic website hosted by the web server/proxy 104 via a URL (e.g., www.example.com) 402 of the dynamic website. For example, the first web client/browser 312_1 may transmit a GET request 404 to the web server/proxy 104 to request the dynamic webpage. In response to the GET request 404, the web server/proxy 104 may provide the code of the requested dynamic webpage, and the first web client/browser 312_1 may interpret the code to load a main page 406 of the dynamic website according to the code.

In some examples, the first web client/browser 312_1 may retrieve the core-static webpage according to the code. For example, the code may include a URL or other suitable link (e.g., .extension/core-statics.jar) to the core-static webpage, and the first web client/browser 312_1 may background fetch 408 the core-static webpage by transmitting a GET request 410 to the web server/proxy 104. In this example, the core-static webpage is retrieved in a background fetch (i.e., not at the same time as the dynamic webpage) so as not to slow down the initial loading of the dynamic webpage. In some examples, the core-static webpage may be provided in a single compressed file, for example, such as a zip file, but the present disclosure is not limited thereto. In response to the GET request 410, the web server/proxy 104 may provide the core-static webpage, and the core-static webpage may be cached 412, for example, in the core-statics cache 316 of the first user device 202_1. Accordingly, the core-static webpage for the dynamic website (e.g., www.example.com) may be made available by the first user device 202_1 to other devices (e.g., the second user device 202_2_ connected through the local network 110 as needed or desired.

While in FIG. 4 the router (e.g., the first router 206) is omitted for convenience of illustration and description, as shown in FIG. 2, the first web client browser 312_1 may communicate with the web server/proxy 104 over the external network 106 via the first router 206 and/or the local network 110. For example, the first router 206 may convert an internal IP address and port combination associated with the first user device 202_1 to an external IP address and port combination for communicating with the web server/proxy 104 and vice versa.

FIG. 5 illustrates a link proxy of the localized subservice system according to one or more examples of the present disclosure. In FIG. 5, the link proxy (also referred to as a link proxy (DNS) or a DNS/proxy) 210_1 is shown as being implemented as part of a DNS server (e.g., an edge DNS server) connected to each of the first and second user devices 202_1 and 202_2 via their routers 206 and 208, but the present disclosure is not limited thereto, and the link proxy 210_1 may be implemented as (or may be included in) any suitable device or server that may orchestrate communications between the routers 206 and 208 of the first and second user devices 202_1 and 202_2 over the local network 110. In FIG. 5, the same reference symbols are used to denote the same or substantially the same elements and components as those described above with reference to one or more examples, and thus, redundant description thereof may not be repeated or may be simplified.

Referring to FIG. 5, the link proxy (DNS) 210_1 may be communicably connected to each of the first router 206 of the first user device 202_1 and the second router 208 of the second user device 202_2 over the local network 110 to orchestrate a communications link between the first user device 202_1 and the second user device 202_2 via their routers 206 and 208. In some examples, when the link proxy (DNS) 210_1 is implemented as part of a DNS server, the link proxy (DNS) 210_1 may also provide DNS services to each of the first user device 202_1 and the second user device 202_2. The link proxy (DNS) 210_1 may include a processing circuit (e.g., one or more processing circuits) 502 having one or more processors 504, memory (e.g., one or more memory or other storage devices) 506, and a communication interface 516. Although illustrated as a single processing circuit 502 in FIG. 5, the processing circuit 502 may be distributed and implemented on multiple computing devices and storage devices.

The processing circuit 502 may be communicably connected to the communication interface 516, such that the processing circuit 502 and the various components thereof can send and receive data via the interface 516. The communication interface 516 may be or include wired or wireless communications interfaces (e.g., jacks, antennas, transmitters, receivers, transceivers, wire terminals, and/or the like) for conducting data communications with the first and second user devices 202_1 and 202_2 (e.g., via their routers 206 and 208). In various examples, communications via the communication interface 516 can be direct (e.g., local wired or wireless communications) or via the network 110. For example, the communication interface 516 may include a Wi-Fi transceiver for communicating via a wireless communications network. In another example, the communication interface 516 may include an Ethernet card and port for sending and receiving data via an Ethernet-based communications link or network. In another example, the communication interface 516 may include cellular or mobile phone communications transceivers. In various examples, the communication interface 516 may support various suitable protocols (e.g., TCP/IP, UDP, HTTP, IMAP, SMTP, and/or the like) and/or data communication interfaces (e.g., API, Web Services, and/or the like) for facilitating data communications with the first and second user devices 202_1 and 202_2 (e.g., via the first and second routers 206 and 208), and/or the like.

The processor 504 may be implemented with one or more general-purpose processors, an ASIC, one or more FPGAs, a DSP, a group of processing components that are distributed over various geographic locations or housed in a single location or device, or other suitable electronic processing components. The memory (e.g., memory device, memory unit, one or more memory devices, storage device, or the like) 506 may be implemented with RAM, NVRAM, ROM, Flash Memory, hard disk storage, cloud storage, and/or other suitable electronic storage devices. The memory 506 stores data and/or computer code for facilitating at least some of the various processes described herein. The memory 506 includes tangible, non-transitory, volatile or non-volatile memory. The memory 506 may include database components, object code components, script components, and/or any other type of information structure for supporting the various activities and information structures described in the present application. According to an embodiment, the memory 506 is communicably connected to processor 504 via the processing circuit 502, and includes computer code for executing (e.g., by processing circuit 502 and/or the processor 504) one or more processes described herein. For example, the memory 506 stores instructions or programming logic that, when executed by the processor 504, controls the operations of the link proxy (DNS) 210_1. In some examples, the processor 504 and the memory 506 may form or be part of various processing circuits in the localized subservice system 200.

In some examples, the memory 502 includes a response generator 510, a resource look-up table (LUT) 512, and a requestor LUT 514. In some examples, if the link proxy (DNS) 210_1 is implemented as part of a DNS server, the memory 502 may further include a DNS service 508. Components 508 to 514 may be configured to receive inputs from the first and second user devices 202_1 and 202_2, the routers 206 and 208, and other data sources, determine actions for the link proxy (DNS) 210_1 based on the inputs, generate control signals based on the actions, and provide the generated control signals to the interface 516 for communicating with the first and second user devices 202_1 and 202_2, the routers 206 and 208, and the other data sources. While FIG. 5 shows that each of the DNS service 508, the response generator 510, the resource LUT 512, and the requestor LUT 514 are part of the same processing circuit 216, the present disclosure is not limited thereto. For example, each of the components 508 to 514 may be implemented on one or more internal processing circuits with respect to the localized subservice system 200 or may be implemented on one or more external processing circuits as part of a cloud-based computing system.

The DNS service 508 may provide domain translation services for the first and second user devices 202_1 and 202_2. For example, when a user enters a URL of a dynamic website in the web client/browser 312, the web client/browser 312 may communicate with the link proxy (DNS) 210_1 to request the IP address corresponding to the URL. The DNS service 508 may lookup (e.g., in an address translation lookup table) the URL to determine the corresponding IP address, and may provide the corresponding IP address to the web client/browser 312 to communicate with the webserver system 104. However, the present disclosure is not limited thereto, and in other examples, the DNS service 508 may be omitted depending on an implementation of the link proxy 210.

The response generator 510 may generate responses to resource announcements and resource requests. For example, in some examples, when a resource device (e.g., the first user device 202_1) announces that it has the core-static webpages of a dynamic website, it may provide an announcement query to inform the link proxy (DNS) 210_1 that it is making the core-static webpages available. The response generator 510 may record information from the announcement query in the resource LUT 512 as well as the external IP address and port combination used by the resource device (e.g., used by the router of the resource device) to communicate the announcement, and may generate a response back to the resource device. The response may include an acknowledgment, for example, if no devices have requested the core-static webpages, or may include information (e.g., IP address and port combination) of one or more requesting devices that have requested the core-static webpages for the corresponding dynamic website.

Similarly, when a requestor device (e.g., the second user device 202_1) fails to retrieve the dynamic webpages from the webserver system 104, the requesting device may request the core-static webpages from the link proxy (DNS) 210_1. For example, in some examples, the requestor device may provide a request query to the link proxy (DNS) 210_1 to request information of one or more resource devices that may have the core-static webpages for the dynamic website available. The response generator 510 may record information from the request query in the requestor LUT 514 as well as the external IP address and port combination used by the requestor device (e.g., used by the router of the requestor device) to communicate the request, and may generate a response back to the requestor device. The response may include an acknowledgement, for example, if no resource devices have the core-static webpages available, or may include information (e.g., IP address and port combination) of one or more resource devices that have the core-static webpages available.

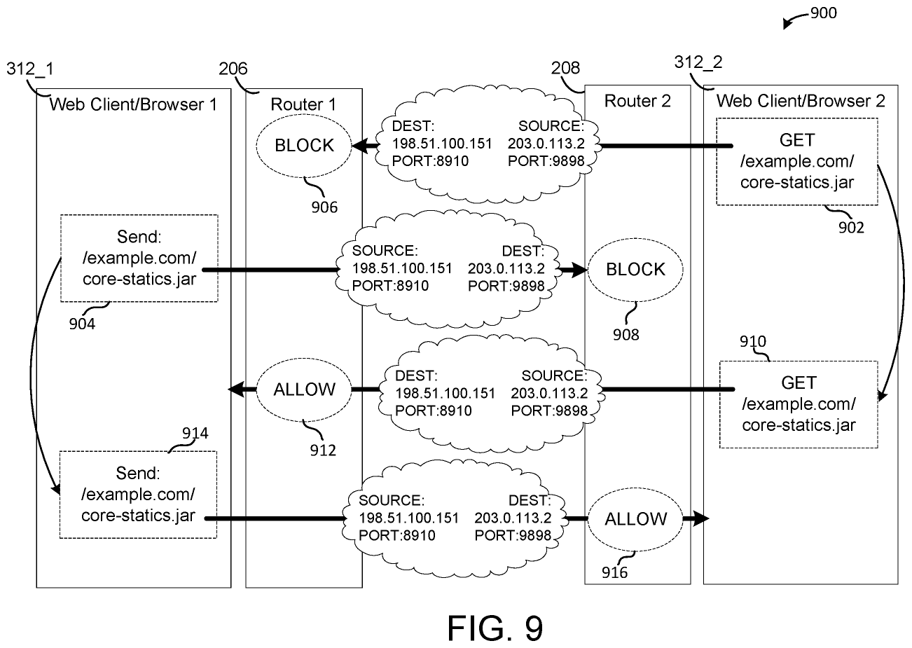

Once the link proxy (DNS) 210_1 provides the IP address and port combination of a requestor device to a resource device, and provides the IP address and port combination of the resource device to the requestor device, the requestor device and the resource device may directly communicate with each other (e.g., via their routers) using the other's IP address and port combination to provide the core-static webpages. For example, as discussed in more detail below with reference to FIG. 9, the requestor device and the resource device may communicate with each other using any suitable hole-punching method (e.g., UDP or TCP hole-punching method), but the present disclosure is not limited thereto.

In other examples, the link proxy (DNS) 210_1 may be omitted depending on an implementation of the localized subservice system 100 or 200. For example, in some examples, an edge DNS sever may act as a resource device. For example, the edge DNS server may store or may be communicably connected to another device or server storing the core-static webpages of various different dynamic websites. In this example, when a user device communicates with the edge DNS server to request the IP address corresponding to a URL of a dynamic website, and the edge DNS server stores data indicating that the dynamic website is unavailable, the edge DNS server may provide the core-static webpages instead of the IP address corresponding to the dynamic website, or may provide the IP address of a different device or server storing the core-static webpages. The edge DNS server may be aware that the dynamic website is unavailable, for example, by periodically monitoring a connection state of the webserver system 104 hosting the dynamic website, or may receive a message from another device that attempted the connection. Accordingly, while the methods described with reference to FIGS. 6 through 9 below are described in the context of the link proxy (DNS) 210_1 (e.g., the DNS/Proxy 210_1), the present disclosure is not limited thereto.

FIG. 6 illustrates a method of announcing a resource of a core-static webpage according to one or more examples of the present disclosure. However, the present disclosure is not limited to the sequence or number of operations of the method 600 shown in FIG. 6, and can be altered into any desired sequence or number of operations as recognized by a person having ordinary skill in the art. For example, in some examples, the order may vary, or the method 600 may include fewer or additional operations. Further, the operations shown in the method 600 may be performed sequentially, or at least some of the operations thereof may be performed concurrently (e.g., simultaneously or substantially simultaneously).

Referring to FIG. 6, the first user device 312_1 (e.g., a resource device) may announce 602 that it has the core-static webpage of a dynamic website (e.g., www.example.com) available. For example, the first web client/browser 312_1 of the first user device 202_1 may have received the core-static webpage from the web server/proxy 104 according to the method 400 shown in FIG. 4, but the present disclosure is not limited thereto. Thus, the first web client/browser 312_1 may transmit an announcement query 606 to the DNS/proxy 210_1 via the first router 206 over the local network 110. The first router 206 may map an internal IP address and port combination (e.g., 192.0.2.1:9876) used by the first user device 202_1 to an external IP address and port combination (e.g., 198.51.100.151:8910) of the first router 206 exposed to the external devices and vice versa. For example, the first router 206 may assign a random external port (e.g., 8910) to the internal IP address and port combination of the first user device 202_1, and may map the internal IP address and port combination to the external IP and assigned port combination in a translation-table 604.

The announcement query 606 may include an identifier of the core-static webpage (e.g., OWNER=“*.example.com.”) that the first web client/browser 312_1 is announcing is available from the first user device 202_1, a record type (e.g., RRTYPE=“PSA”), and a time value (e.g., OPT {attribute,value}={TTL,300}) that the first user device 202_1 will maintain the core-static webpage to be available. For example, the record type “PSA” may indicate that the request query 606 is associated with a query for a core-static webpage, and in some examples, may be assigned by a standards body. In this example, the “OPT {attribute, value}” pair represents EDNS(0) (e.g., Extension mechanisms for DNS— Ver. 0), and allows additional metadata to be provided with a DNS query or response, but the present disclosure is not limited thereto. The {TTL,300} may indicate the time-to-live (TTL) that the core statics resource will be maintained, which may be for 300 second intervals in this example, but the time period of the TTL may be variously modified as needed or desired. The announcement query 606 shown in FIG. 6 is provided as an example, however, and the present disclosure is not limited thereto.

In response to the announcement query 606, the DNS/proxy 210_1 may record 608 a resource identifier (e.g., “example.com”) and the external IP address and port combination of the first device 202_1 in the resource LUT 512. In some examples, the DNS/proxy 210_1 may also record the TTL of the core-static webpage in the resource LUT 512, which may be extended by the loop-timer 316 of the first user device 202_1. For example, the loop-timer 316 of the first user device 202_1 may be used to extend the TTL of the core statics resource in the 300 second intervals, while enabling the IP address and port combinations of the first router 206 to remain active. For example, the loop-timer 316 may have a duration that is shorter than the TTL, and each loop of the loop-timer may 316 may reset the TTL for another 300 second interval, in this example. The number of loops of the loop-timer 316 may be user configurable, such that when the loop-timer 316 ends, the core-static webpage will remain accessible for the final 300 second TTL interval.

The DNS/proxy 210_1 may provide a response 610 to the first web client/browser 312_1 of the first user device 202_1 via the first router 206. For example, the response 610 may include an acknowledgment as shown in FIG. 6, for example, if no devices have requested the core-static webpages. In this case, the response 610 may include a null data field (e.g., RDLENGTH=0) and a protocol specific OPT {attribute, value} pair (e.g., {CSRECS, 0}), indicating that there are currently no requestor devices waiting for the core-static webpages. Accordingly, in order for the first user device 202_1 to maintain the core-static webpages and to keep the IP address and port combinations through the first router 206 active, the loop-timer 316 of the first user device 202_1 may be invoked to periodically cause the web client/browser 312_1 to re-announce the core-static webpages. For example, for each loop of the loop-timer 316, the web client/browser 312_1 may transmit another announcement query 606 to the DNS/proxy 210_1 through the first router 206 using the same IP address and port combinations to extend the TTL of the core-static webpages while keeping the same IP address and port combination active.

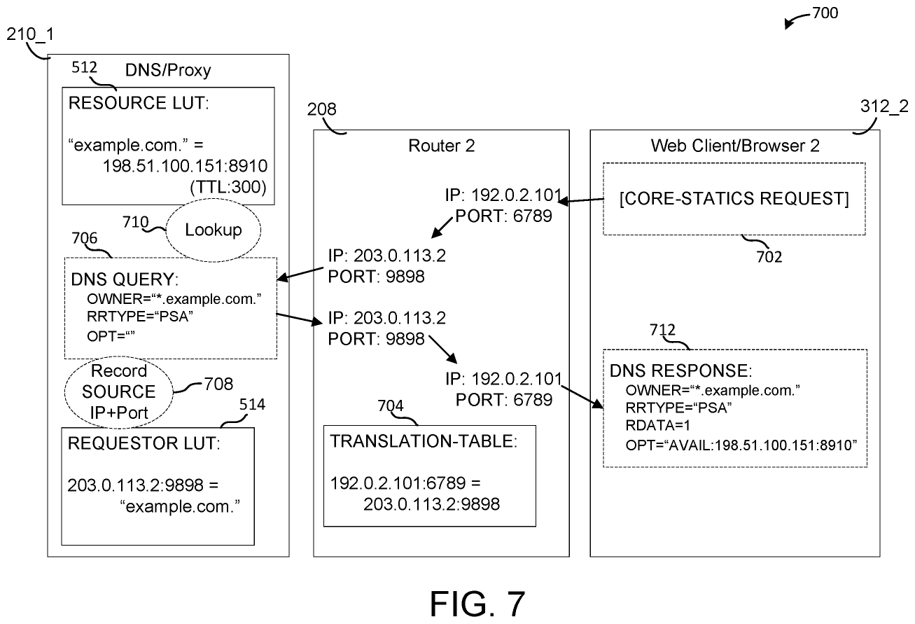

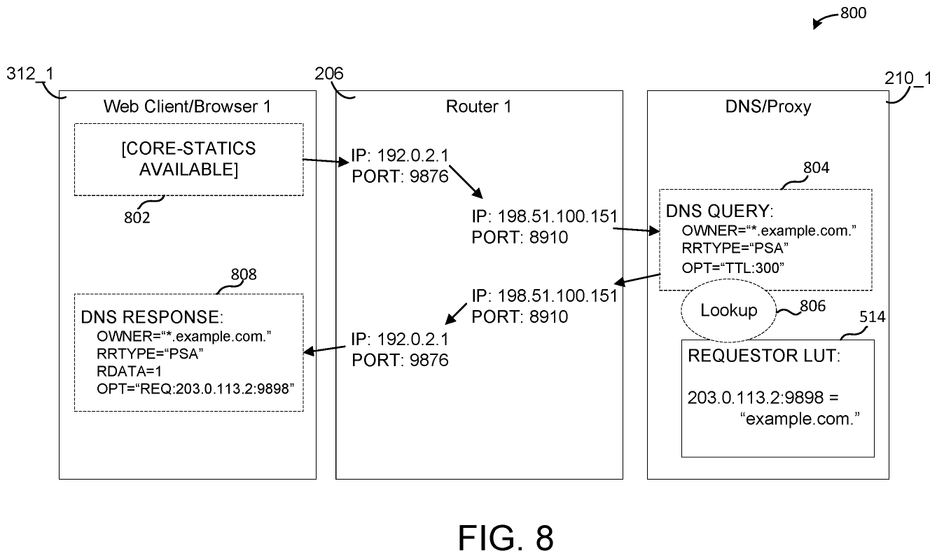

As discussed in more detail with reference to FIGS. 7 and 8, when a requestor device has already requested the core-static webpages, the response 808 (e.g., see FIG. 8) may include information (e.g., IP address and port combination) of the requestor device, such that the resource device (e.g., the first user device 202_1) may communicate directly with the requestor device (e.g., the second user device 202_2) via their routers 206 and 208 to provide the core-static webpages as discussed in more detail below with reference to FIG. 9.

FIGS. 7-8 illustrate a method of requesting a resource of a core-static webpage according to one or more examples of the present disclosure. FIG. 7 illustrates a method 700 of requesting a core-static webpage according to one or more examples of the present disclosure, and FIG. 8 illustrates a method 800 of providing information of a requestor device to a resource device according to one or more examples of the present disclosure. However, the present disclosure is not limited to the sequence or number of operations of the methods 700 and 800 shown in FIGS. 7 and 8, and can be altered into any desired sequence or number of operations as recognized by a person having ordinary skill in the art. For example, in some examples, the order may vary, or the methods 700 and 800 may include fewer or additional operations. Further, the operations shown in the methods 700 and 800 may be performed sequentially, or at least some of the operations thereof may be performed concurrently (e.g., simultaneously or substantially simultaneously).

First, referring to FIG. 7, subsequent to the announcement 602 of the method 600 of FIG. 6, the second user device 202_2 may request 702 the core-static webpages from the DNS/proxy 210_1. For example, in response to the webserver system 104 being unavailable to provide the dynamic webpages of the dynamic website (e.g., www.example.com) over the external network 106, the second web client/browser (e.g., web client/browser 2) 312_2 of the second user device 202_2 may transmit a request query 706 to the DNS/proxy 210_1 via the second router 208 over the local network 110 to request information of a resource device that may have the core-static webpages of the dynamic website (e.g., www.example.com) available. The second router 208 may map an internal IP address and port combination (e.g., 192.0.2.101:6789) used by the second user device 202_2 to an external IP address and port combination (e.g., 203.0.113.2:9898) of the second router 208 exposed to the external devices and vice versa. For example, the second router 208 may assign a random external port (e.g., 9898) to the internal IP address and port combination of the second user device 202_2, and may map the internal IP and port combination to the external IP address and assigned port combination in a translation-table 704.

The request query 706 may include an identifier of the core-static webpages (e.g., OWNER=“*.example.com.”) that the second web client/browser 312_2 is requesting, the record type (e.g., RRTYPE=“PSA”) indicating that the request is for a core-static webpage, and an OPT {attribute, value} pair (e.g., {CSMSG, “REQ”}) indicating that the query is a request query rather than an announcement query. However, the request query 706 shown in FIG. 7 is provided as an example, and the present disclosure is not limited thereto.

In response to the request query 706, the DNS/proxy 210_1 may record 708 a resource identifier (e.g., “example.com”) and the external IP address and port combination of the second device 202_2 in the requestor LUT 514, and may lookup 710 the resource LUT 512 to determine if there are any resource devices that have announced that the requested core-static webpage is available. The DNS/proxy 210_1 may provide a response 712 to the second web client/browser 312_2 of the second user device 202_2 via the second router 208. For example, the response 712 may include information of a requestor device as shown in FIG. 7, for example, if the resource device is available to provide the requested core statics resource. In this case, the response 712 may include a “1” data field (e.g., RDATA=1) and the IP and port combination of the resource device (e.g., the first user device 202_1) in the protocol specific OPT {attribute, value} pair (e.g., {CSMSG, “AVAIL:198.51.100.151:8910”}), indicating that the core-static webpage is available from 1 resource device (e.g., the first user device 202_1) at the provided IP address and port combination. However, the response 712 may include an acknowledgment, for example, if no resource devices are currently available to provide the core-static webpage. In this case, the RDATA field and protocol specific OPT {attribute, value} pairs may be empty or null, indicating that there are currently no resource devices available to provide the requested core-static webpage.

Referring to FIG. 8, subsequently, the first user device 202_1 may re-announce 802 that it has the core-static webpages of the dynamic website (e.g., www.example.com) available. For example, a loop of the loop-timer 316 of the first user device 202_1 may expire, causing the first web client/browser 312_1 of the first user device 202_1 to initiate another announcement query 804 via the first router 206 using the same IP address and port combination. In this example, the DNS/proxy 210_1 may lookup 806 the requestor LUT 514 to determine whether there are any requestor devices (e.g., the second user device 202_2) requesting the core-static webpage, and may generate a response 808 with information of one or more requestor devices requesting the core-static webpage. For example, the response 808 may include the 1 data filed (e.g., RDATA=1), indicating that there is 1 requestor device waiting for the core-static webpage, and the IP and port combination information of the 1 requestor device (e.g., OPT {attribute, value pair} of {CS,“REQ:203.0.113.2:9898”}). Accordingly, both the first user device 202_1 (e.g., the resource device) and the second user device 202_2 (e.g., the requestor device) may have the information needed to directly connect to each other (e.g., via their routers 206 and 208) as discussed in more detail below with reference to FIG. 9.

FIG. 9 illustrates a method of providing a core-static webpage according to one or more examples of the present disclosure. However, the present disclosure is not limited to the sequence or number of operations of the method 900 shown in FIG. 9, and can be altered into any desired sequence or number of operations as recognized by a person having ordinary skill in the art. For example, in some examples, the order may vary, or the method 900 may include fewer or additional operations. Further, the operations shown in the method 900 may be performed sequentially, or at least some of the operations thereof may be performed concurrently (e.g., simultaneously or substantially simultaneously).

Referring to FIG. 9, once each of the first user device 202_1 and the second user device 202_2 has the IP and port combination information of the other as discussed above with reference to FIGS. 7 and 8, the first user device 202_1 and the second user device 202_2 may establish a communications link with each other to exchange the core-static webpage. For example, the first web client/browser 312_1 may use the public IP address and port combination (e.g., 203.0.113.2:9898) of the second user device 202_2 received from the DNS/proxy 210_1 and the second web client/browser 312_2 may use the public IP address and port combination (e.g., 198.51.100.151:8910) of the first user device 202_1 received from the DNS/proxy 210_1 to establish a direct communications link with each other (e.g., via their routers 206 and 208).

In some examples, as shown in FIG. 9, in order to traverse their respective routers 206 and 208, a packet may need to originate from the corresponding user device 202_1 or 202_2 before being able to receive a packet from the other user device. For example, a GET request 902 for the core-static webpage from the second web client/browser 312_2 may be blocked 906 by the first router 206 until a packet originates from the first user device 202_1 to the second user device 202_2, and a send request 904 of the core-static webpage from the first web client/browser 312_1 may be blocked 908 by the second router 208 until a packet originates from the second user device 202_2 to the first user device 202_1. On the other hand, once each of the first web client/browser 312_1 and the second web client/browser 312_2 originates a packet to the other, the first and second routers 206 and 208 may allow the first and second web client/browsers 312_1 and 312_2 to exchange packets with each other.

For example, as shown in FIG. 9, a subsequent GET request 910 for the core-static webpage from the second web client/browser 312_2 may be allowed 912 by the first router 206, and a subsequent send request 914 of the core-static webpage from the first web client/browser 312_1 may be allowed 916 by the second router 208. Once the core-static webpage is received by the second user device 202_2, the second user device 202_2 may then be provided the option of becoming a resource device of the core-static webpage received from the first user device 202_1, for example, by announcing that it is a resource device of the core-static webpage according to the method 600 of FIG. 6. However, the present disclosure is not limited thereto, and the methods 400, 600, 700, 800, and 900 may be variously modified according to an implementation of the localized subservice system 100 or 200.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

When a certain embodiment may be implemented differently, a specific process order may be different from the described order. For example, two consecutively described processes may be performed at the same or substantially at the same time, or may be performed in an order opposite to the described order.

The terminology used herein is for the purpose of describing particular examples and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing examples of the present disclosure refers to “one or more examples of the present disclosure.” As used herein, the terms “use,” “using,” and “used” may be considered synonymous with the terms “utilize,” “utilizing,” and “utilized,” respectively.

The electronic or electric devices and/or any other relevant devices or components according to examples of the present disclosure described herein may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the examples of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Although some examples have been described, those skilled in the art will readily appreciate that various modifications are possible in the examples without departing from the spirit and scope of the present disclosure. It will be understood that descriptions of features or aspects within each embodiment should typically be considered as available for other similar features or aspects in other examples, unless otherwise described. Thus, as would be apparent to one of ordinary skill in the art, features, characteristics, and/or elements described in connection with a particular embodiment may be used singly or in combination with features, characteristics, and/or elements described in connection with other examples unless otherwise specifically indicated. Therefore, it is to be understood that the foregoing is illustrative of various example examples and is not to be construed as limited to the specific examples disclosed herein, and that various modifications to the disclosed examples, as well as other example embodiments, are intended to be included within the spirit and scope of the present disclosure as defined in the appended claims, and their equivalents.

What is claimed is:

1. A system comprising:
a webserver system configured to host a dynamic webpage;
a requestor device configured to communicate with the webserver system over a first network to receive the dynamic webpage; and
a resource device communicably connected to the requestor device over a second network, and configured to cache a core-static webpage corresponding to the dynamic webpage,
wherein, in response to the webserver system being unavailable to provide the dynamic webpage, the requestor device is configured to communicate with the resource device over the second network to request the core-static webpage.

2. The system of claim 1, wherein the resource device is communicably connected to the webserver system over the first network, and is configured to receive the core-static webpage from the webserver system.

3. The system of claim 2, wherein the resource device comprises a first web client/browser configured to:
request a code for the dynamic webpage from the webserver system;
interpret the code to display a main page of the dynamic webpage;
identify the core-static webpage from a link in the code; and
fetch the core-static webpage from the link to cache the core-static webpage.

4. The system of claim 1, further comprising a link proxy communicably connected to each of the resource device and the requestor device over the second network, the link proxy configured to provide connection information of the resource device to the requestor device and to provide connection information of the requestor device to the resource device.

5. The system of claim 4, wherein the connection information of the resource device comprises a public Internet protocol (IP) address and port of a first router connected to the resource device, and the connection information of the requestor device comprises a public IP and port of a second router connected to the requestor device.

6. The system of claim 5, wherein the resource device and the requestor device are configured to directly communicate with each other using the first router and the second router according to the connection information received from the link proxy.

7. The system of claim 6, wherein the resource device and the requestor device are configured to directly communicate with each other using user datagram protocol (UDP) hole-punching.

8. The system of claim 6, wherein the resource device and the requestor device are configured to directly communicate with each other using transmission control protocol (TCP) hole-punching.

9. The system of claim 5, wherein the resource device is configured to transmit an announcement query to the link proxy, the announcement query comprising information related to the core-static webpage cached thereon and the public IP and port of the first router.

10. The system of claim 6, wherein the requestor device is configured to transmit a request query to the link proxy, the request query comprising information related to the requested core-static webpage and the public IP and port of the second router.

11. A method, comprising:
sending, by a first client device to a webserver system, a request for a dynamic webpage, wherein the request is sent at least partially over a first network;
receiving, at the first client device, a code for the dynamic webpage;
interpreting, by the first client device, the code to display a page of the dynamic webpage;
identifying, by the first client device, the code to identify the core-static webpage from a link in the code;
fetching, by the first client device, a core-static webpage using the link, wherein the core-static webpage is different from the dynamic webpage;
caching the core-static webpage at the first client device;
receiving, from a second client device and at least partially over a second network, a request for the core-static webpage; and
sending the core-static webpage from the first client device to the second client device.

12. The method of claim 12, wherein the fetching of the core-static webpage occurs following display of the dynamic webpage.

13. The method of claim 11, wherein the request for the core-static webpage is received from router associated with the second client device over the second network.

14. The method of claim 11, further comprising, after the first client device caches the core-static webpage, announcing to a link proxy that the first client device is storing the core-static webpage.

15. The method of claim 14, wherein the announcement to the link proxy includes a combination of an IP address and a port.

16. The method of claim 11, further comprising:
sending, by the first client device, a request for a second dynamic webpage to the webserver system;
determining that the webserver is system is unavailable;
sending, by the first client device, a request for a second core-static webpage related to the second dynamic webpage to the second client device; and
receiving the second core-static webpage.

17. The method of claim 11, further comprising:
initiating, based on caching the core-static webpage at the first client device, a loop-timer; and
deleting, upon expiration of the loop-timer, the core-static webpage at the first client device.

18. A system, comprising:
at least one processor; and
memory, operatively connected to the at least one processor and storing instructions that, when executed by the at least one processor, cause the system to perform a method, the method comprising:
sending, by a first client device to a webserver system, a request for a dynamic webpage, wherein the request is sent at least partially over a first network;
receiving, at the first client device, a code for the dynamic webpage;
interpreting, by the first client device, the code to display a page of the dynamic webpage;
identifying, by the first client device, the code to identify the core-static webpage from a link in the code;
fetching, by the first client device, a core-static webpage using the link, wherein the core-static webpage is different from the dynamic webpage;
caching the core-static webpage at the first client device;
receiving, from a second client device and at least partially over a second network, a request for the core-static webpage; and
sending the core-static webpage from the first client device to the second client device.

19. The system of claim 18, wherein the fetching of the core-static webpage occurs following display of the dynamic webpage.

20. The system of claim 18, wherein the method further comprises:
sending, by the first client device, a request for a second dynamic webpage to the webserver system;
determining that the webserver is system is unavailable;
sending, by the first client device, a request for a second core-static webpage related to the second dynamic webpage to the second client device; and
receiving the second core-static webpage.
